(19) United States
(12) Patent Application Publication
(10) Pub. No.: US 2022/0131873 A1
(43) Pub. Date: Apr. 28, 2022

(54) Transaction Replacement Method, Device, and Storage Medium

(71) Applicant: HANGZHOU FUZAMEI TECHNOLOGY CO., LTD., Hangzhou, Zhejiang (CN)

(72) Inventors: Sijin WU, Suzhou (CN); Zhiwen WANG, Suzhou (CN); Dehai CHEN, Suzhou (CN)

(21) Appl. No.: 17/432,076

(22) PCT Filed: Feb. 20, 2020
(86) PCT No.: PCT/CN2020/075946

§ 371 Date: Aug. 18, 2021

(30) Foreign Application Priority Data
Feb. 22, 2019 (CN) 201910135410.X

(51) Int. Cl. H04L 9/40; H04L 9/32; G06F 16/23

(52) U.S. Cl. CPC H04L 63/12; H04L 2209/38; G06F 16/2308; H04L 9/3247

(57) ABSTRACT

The present invention provides a transaction replacing method, device, and storage medium, wherein the method comprises selecting the predecessor transaction for replacement by means of disposing a predecessor transaction message for the transaction to be stored into the pre-transaction pool, wherein when the predecessor transaction for replacement is still in the pre-transaction pool, marking the predecessor transaction for replacement as discard and storing the transaction into the pre-transaction pool; when a confirmation message of the transaction is received, storing the transaction into the transaction pool and when the transaction is packaged, deleting all predecessor transactions of the transaction. The present invention allows modification of the transaction content before the transaction enters the transaction pool and prevents the predecessor transaction from being sent back.

### BACKGROUND OF THE PRESENT INVENTION

### Field of Invention

The present invention relates to the technical field of blockchain, and in particular, to a transaction replacing method, device, and storage medium.

### Description of Related Arts

During the blockchain transaction, the user may need to fill in messages, such as the sender address, the receiver address, the number of transaction, and etc., to conduct the transaction. In the prior art, these messages have to be determined before the transaction is submitted. Once submitted, these messages cannot be changed. Therefore, the user may have irreparable loss after mis-operation.

With respect to the above issues, some organizations propose a transaction replacement method, which includes deleting a prior transaction before replacement in a transaction pool and then placing the transaction after replacement into the transaction pool to wait for packaging. Nevertheless, a certain delay exists in different nodes in the blockchain, and all nodes cannot guarantee a strong synchronization relationship. For example, when the node A deletes the prior transaction before replacement and place the replacement transaction into the transaction pool to wait for packaging, it receives the prior transaction from the node B again, the node A will put the prior transaction into the transaction pool again and wait for packaging, and if the two transactions are both packaged eventually, it will render transaction error.

### SUMMARY OF THE PRESENT INVENTION

In accordance of the defects or drawbacks of the conventional technologies, the present invention aims to provide a transaction replacing method, device, and storage medium, which allows modification of the transaction content before the transaction enters the transaction pool and prevents the transaction from being sent back.

In a first aspect, the present invention provides a transaction replacing method, comprising:

receiving a first transaction transmitted by a client and determining, by means of whether a first predecessor transaction information of the first transaction is null, whether the first transaction to be stored into a transaction pool is a first-type transaction for replacing a predecessor transaction or a second-type transaction not for replacing a predecessor transaction:

if the first transaction is a second-type transaction, then saving the first transaction into the pre-transaction pool;

if the first transaction is a first-type transaction, then querying whether the predecessor transaction of the first transaction is present in the pre-transaction pool on the basis of the first predecessor transaction information:

if yes, marking the first predecessor transaction as discard and saving the first transaction into the pre-transaction pool; and

receiving a first confirmation message sent from the client for confirming the first transaction and saving the first transaction into the transaction pool and generating a second confirmation message of the confirmation of the first transaction and sending to other node of the blockchain; or receiving the second confirmation message sent from other node of the blockchain and saving the first transaction into the transaction pool;

after the first transaction is packaged, querying the first predecessor transaction of the first transaction according to the first predecessor transaction information;

querying if a previous predecessor transaction exist on the basis of the information of the queried predecessor transaction of the transaction and repeating this step until no more predecessor transaction was found; and

deleting the first predecessor transaction and all the predecessor transactions that were found.

In a second aspect, the present invention provides a transaction replacing method, comprising:

generating a first transaction and sending to a node of a blockchain so as for the node of the blockchain to receive the first transaction and to determine, by means of whether a first predecessor transaction information of the first transaction is null, whether the first transaction to be stored into a transaction pool is a first-type transaction for replacing a predecessor transaction or a second-type transaction not for replacing a predecessor transaction:

if the first transaction is a second-type transaction, then saving the first transaction into the pre-transaction pool;

if the first transaction is a first-type transaction, then querying whether the predecessor transaction of the first transaction is present in the pre-transaction pool on the basis of the first predecessor transaction information:

if yes, marking the first predecessor transaction as discard and saving the first transaction into the pre-transaction pool; and

sending a first confirmation message for confirming the first transaction to the node of the blockchain so as for the node of the blockchain to receive the first confirmation message, to save the first transaction into the transaction pool, and to generate a second confirmation message that confirms the first transaction and send to other node of the blockchain;

after the first transaction is packaged, querying the first predecessor transaction of the first transaction according to the first predecessor transaction information;

querying if a previous predecessor transaction exist on the basis of the information of the queried predecessor transaction of the transaction and repeating this step until no more predecessor transaction was found; and

deleting the first predecessor transaction and all the predecessor transactions that were found.

In a third aspect, the present invention provides a transaction replacing method, comprising:

receiving a first transaction transmitted by a client and determining, by means of whether a first predecessor transaction information of the first transaction is null, whether the first transaction to be stored into a transaction pool is a first-type transaction for replacing a predecessor transaction or a second-type transaction not for replacing a predecessor transaction:

if the first transaction is a second-type transaction, then saving the first transaction into the pre-transaction pool;

if the first transaction is a first-type transaction, then querying whether the predecessor transaction of the first transaction is present in the pre-transaction pool on the basis of the first predecessor transaction information:

if yes, saving the first transaction into the pre-transaction pool;

receiving a third confirmation message sent from the client for confirming the first transaction and saving the first transaction into the transaction pool and generating a fourth confirmation message of the confirmation of the first transaction and sending to other node of the blockchain; or receiving the fourth confirmation message sent from other node of the blockchain and saving the first transaction into the transaction pool;

determining, by means of whether a first predecessor transaction information of the first transaction is null, whether the first transaction to be packaged is a first-type transaction for replacing a predecessor transaction or a second-type transaction not for replacing a predecessor transaction:

if the first transaction is a second-type transaction, then packaging the first transaction;

if the first transaction is a first-type transaction, then querying the first predecessor transaction of the first transaction according to the first predecessor transaction information,

querying if a previous predecessor transaction exist on the basis of the information of the queried predecessor transaction of the transaction and repeating this step until no more predecessor transaction was found; and

deleting the first predecessor transaction and all the predecessor transactions that were found and packaging the first transaction.

In a fourth aspect, the present invention provides a transaction replacing method, comprising:

generating a first transaction and sending to a node of a blockchain so as for the node of the blockchain to receive the first transaction and to determine, by means of whether a first predecessor transaction information of the first transaction is null, whether the first transaction to be stored into a transaction pool is a first-type transaction for replacing a predecessor transaction or a second-type transaction not for replacing a predecessor transaction:

if the first transaction is a second-type transaction, then saving the first transaction into the pre-transaction pool;

if the first transaction is a first-type transaction, then querying whether the predecessor transaction of the first transaction is present in the pre-transaction pool on the basis of the first predecessor transaction information:

if yes, saving the first transaction into the pre-transaction pool;

sending a third confirmation message for confirming the first transaction to the node of the blockchain so as for the node of the blockchain to receive the third confirmation message, to save the first transaction into the transaction pool, and to generate a fourth confirmation message that confirms the first transaction and send to other node of the blockchain, and determining, by means of whether a first predecessor transaction information of the first transaction is null, whether the first transaction to be packaged is a first-type transaction for replacing a predecessor transaction or a second-type transaction not for replacing a predecessor transaction:

if the first transaction is a second-type transaction, then packaging the first transaction;

if the first transaction is a first-type transaction, then querying the predecessor transaction of the first transaction according to the first predecessor transaction information,

querying if a previous predecessor transaction exist on the basis of the information of the queried predecessor transaction of the transaction and repeating this step until no more predecessor transaction was found; and

deleting the first predecessor transaction and all the predecessor transactions that were found and packaging the first transaction.

In a fifth aspect, the present invention also provides a device, which includes one or more processors and a storage, wherein the storage includes commands executable by the one or more processors to allow the one or more processors to perform transaction replacing method provided in accordance with one or more embodiments of the present invention.

In a sixth aspect, the present invention also provides a storage medium with computer program stored therein, so as for allowing a computer to perform a transaction replacing method provided in accordance with the embodiments of the present invention.

Transaction replacing method, device, and storage medium, provided by the embodiments of the present invention, utilize a method of selecting the predecessor transaction for replacement by means of disposing a predecessor transaction message for the transaction to be stored into the pre-transaction pool, wherein when the predecessor transaction for replacement is still in the pre-transaction pool, marking the predecessor transaction for replacement as discard and storing the transaction into the pre-transaction pool, and when a confirmation message of the transaction is received, storing the transaction into the transaction pool and when the transaction is packaged, deleting all predecessor transactions of the transaction, so as to allow modification of the transaction content before the transaction enters the transaction pool and prevent the predecessor transaction from being sent back.

The transaction replacing method, device, and storage medium, provided by the embodiment of the present invention, further utilizes the method that judges and determines if the first address sending the first transaction and the second address sending the first predecessor transaction are the same: if yes, it marks the first predecessor transaction as discard and saves the first transaction into the pre-transaction pool, so as to avoid different users from maliciously sending a first transaction to replace a first predecessor transaction that does not belong to him/her, thereby such that the security of the blockchain system can be increased and the user experience can further be enhanced.

The transaction replacing method, device, and storage medium, provided by the embodiment of the present invention, further utilizes the method that calculates the quantity of predecessor transaction owned by a transaction and compares it to the threshold of the quantity of predecessor transaction that is pre-configured in the system, wherein if the quantity of predecessor transaction of the transaction is greater than the pre-configured threshold of the quantity of predecessor transaction, it will discard the transaction, so as to restrict that a transaction may not have too many predecessor transactions, so as to prevent some malicious user from jamming the pre-transaction pool through constantly sending transaction to replace a predecessor transaction, so that the security of the blockchain system can be enhanced and the user experience can be further improved.

The transaction replacing method, device, and storage medium, provided by the embodiment of the present invention, further utilizes the method that configures a threshold of deposit time of the transaction in the pre-transaction pool; and monitors if the waiting time of the transaction of the pre-transaction pool exceeds the configured threshold of waiting time: if yes, deleting the transaction, so that transactions of overly long deposit time in the pre-transaction pool will be deleted to release the storage space of the pre-transaction pool, so as to enhance the security of the blockchain system and further improve the user experience.

### BRIEF DESCRIPTION OF THE DRAWINGS

Other features, objects, and advantages of the present application will become more obvious through referring to the detail descriptions of the embodiments that are illustrated in, but not limited by the following figures.

FIG. 1 is a flow diagram of a transaction replacing method according to an embodiment of the present invention.

FIG. 2 is a flow diagram of a step S15 of the method illustrated in FIG. 1 according to a preferred embodiment of the present invention.

FIG. 3 is a flow diagram of a step S15 of the method illustrated in FIG. 1 according to a preferred embodiment of the present invention.

FIG. 4 is a flow diagram of a step S12 of the method illustrated in FIG. 1 according to a preferred embodiment of the present invention.

FIG. 5 is a flow diagram of a transaction replacing method according to an embodiment of the present invention of the present invention.

FIG. 6 is a flow diagram of a step S211 of the method illustrated in FIG. 5 according to a preferred embodiment of the present invention.

FIG. 7 is a composition diagram of a device according to an embodiment of the present invention.

### DETAILED DESCRIPTION OF THE PREFERRED EMBODIMENT

The present application is described in further detail below in connection with the accompanying drawings and embodiments. It is to be understood that the specific embodiments described herein are for illustrative purposes only and shall not limit the present invention. It is also to be noted that, for ease of description, only portions that are relevant to the present invention to be described are shown in the accompanying drawings.

It should be noted that, without conflict, features in the present application and features in the embodiments may be combined with each other. The present application will now be described in detail with reference to the accompanying drawings.

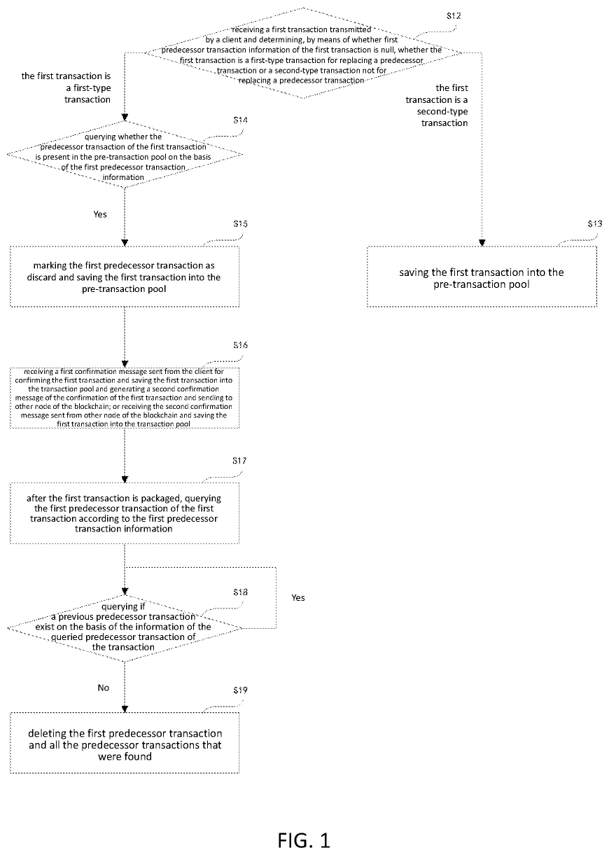

FIG. 1 is a flow diagram of a transaction replacing method according to an embodiment of the present invention.

Referring to FIG. 1, according to the present embodiment, a transaction replacing method provided by the present invention comprises:

S12: receiving a first transaction transmitted by a client and determining, by means of whether a first predecessor transaction information of the first transaction is null, whether the first transaction to be stored into a transaction pool is a first-type transaction for replacing a predecessor transaction or a second-type transaction not for replacing a predecessor transaction:

if the first transaction is a second-type transaction, then executing the step S13: saving the first transaction into the pre-transaction pool;

if the first transaction is a first-type transaction, then executing the step S14:

querying whether the predecessor transaction of the first transaction is present in the pre-transaction pool on the basis of the first predecessor transaction information:

if yes, executing the step S15: marking the first predecessor transaction as discard and saving the first transaction into the pre-transaction pool; and

S16: receiving a first confirmation message sent from the client for confirming the first transaction and saving the first transaction into the transaction pool and generating a second confirmation message of the confirmation of the first transaction and sending to other node of the blockchain; or receiving the second confirmation message sent from other node of the blockchain and saving the first transaction into the transaction pool;

S17: after the first transaction is packaged, querying the first predecessor transaction of the first transaction according to the first predecessor transaction information;

S18: querying if a previous predecessor transaction exist on the basis of the information of the queried predecessor transaction of the transaction and repeating this step until no more predecessor transaction was found; and

S19: deleting the first predecessor transaction and all the predecessor transactions that were found.

Specifically, the first transaction generated and sent by the user has a predecessor transaction message, predecessor, and a discard message, discard, configured therewith. The first predecessor transaction information is the transaction hash of the predecessor transaction of the first transaction. When the first transaction does not have a predecessor transaction, the predecessor transaction message of the first transaction is null. The discard message is utilized for marking the discard status of a transaction. The first confirmation message sent by the user for confirming the first transaction is the transaction hash of the first transaction that has been signed by the user. The node A generates a second confirmation message that confirms the first transaction, wherein the second confirmation message is consistent to the first confirmation message.

Giving the following as the example: the discard status of false indicates that the transaction is not discarded, while the discard status of true indicates that the transaction is discarded; if there are currently 100 transactions, tx_1˜tx_100 in the pre-transaction pool and there is no transaction in the transaction pool; when the user A generates a tx_101 and a tx_102 and sends them to the node A of the blockchain, wherein the predecessor of the tx_101 is null, the predecessor of the tx_102 is hash(tx_80), the predecessor of the tx_80 is hash(tx_60), and the predecessor of the tx_60 is null, then when the user A confirms the correctness of the tx_102 and sends sig(hash(tx_102)) to the node A of the blockchain, the second confirmation message is consistent to the first confirmation message, which is also sig(hash(tx_102)).

The user A generates the tx_101 and the tx_102 and sends them to the node A of the blockchain.

When the node A receives the tx_101:

in the step S12, the node A receives a tx_101 transmitted by the user A and determines if the tx_101 to be stored into the pre-transaction pool is a first-type transaction for replacing the predecessor transaction or a second-type transaction not for replacing the predecessor transaction by means of whether the predecessor of the tx_101 is null:

because the predecessor of the tx_101 is null, the tx_101 is a second-type transaction, therefore executing the step S13: saving the tx_101 into the pre-transaction pool.

When the node A receives the tx_102:

in the step S12, the node A receives a tx_102 transmitted by the user A and determines if the tx_102 to be stored into the pre-transaction pool is a first-type transaction for replacing the predecessor transaction or a second-type transaction not for replacing the predecessor transaction by means of whether the predecessor of the tx_102 is null:

because the predecessor of the tx_102 is hash(tx_80), therefore tx_102 is a first-type transaction, then executing the step S14: querying whether the predecessor transaction tx_80 of the tx_102 is present in the pre-transaction pool on the basis of the hash(tx_80):

because there are 100 transactions, tx_1˜tx_100, in the pre-transaction pool, wherein the tx_80 is also in the pre-transaction pool, therefore executing the step S15: marking the tx_80 as discard, which turns the false of the discard of the tx_80 into true, and save the tx_102 into the pre-transaction pool; and

in the step S16, the node A receives sig(hash(tx_102)) transmitted by the user A, saves the tx_102 into the transaction pool, and generates a second confirmation message that the first transaction has been confirmed. Because the second confirmation message is consistent to the first confirmation message, which is also sig(hash(tx_102)), therefore, the node A sends sig(hash(tx_102)) to other nodes of the blockchain; or the node A receives the second confirmation message of sig(hash(tx_102)) sent from other nodes, and saves the tx_102 into transaction pool.

In the step S17, after the tx_102 is packaged, the node A, according to hash(tx_80), queries the first predecessor transaction of the tx_102 as hash(tx_80).

In the step S18, the node A queries if a previous predecessor transaction exist on the basis of the information of the queried predecessor transaction of the transaction and repeating this step until no more predecessor transaction was found; querying if there is a previous predecessor transaction according to the predecessor of the tx_80, wherein the predecessor of tx_80 is hash(tx_60) and the previous predecessor transaction of the tx_80 is tx_60, therefore, querying if a previous predecessor transaction of the predecessor of the tx_60 exist and ending the cycle if no predecessor transaction of the tx_60 is found.

In the step S19, the node A deletes the tx_80 and the tx_60.

The principle of preventing the transaction from being sent back is in that: when another node of the blockchain, node B for example, sends tx_80 back to the node A due to network delay or other issue; if the tx_102 has not been packaged by then, the node A determines based on that there is the tx_80 in the pre-transaction pool and the tx_80 is marked as discard, so the node A will discard the tx_80 sent from the node B; if by then the tx_102 has been packaged and the tx_80 and the tx_60 have both been deleted from the pre-transaction pool, the node A will check if the block height of the node B is consistent to its. Because the node A has packaged the tx_102 and the node B is still in the stage of sending back tx_80, the block height of the node A is certainly higher than the block height of the node B. Therefore, the node A will discard the tx_80 sent from the node B.

The above embodiment utilizes a method of selecting the predecessor transaction for replacement by means of disposing a predecessor transaction message for the transaction to be stored into the pre-transaction pool, wherein when the predecessor transaction for replacement is still in the pre-transaction pool, marking the predecessor transaction for replacement as discard and storing the transaction into the pre-transaction pool, and when a confirmation message of the transaction is received, storing the transaction into the transaction pool and when the transaction is packaged, deleting all predecessor transactions of the transaction, so as to allow modification of the transaction content before the transaction enters the transaction pool and prevent the predecessor transaction from being sent back.

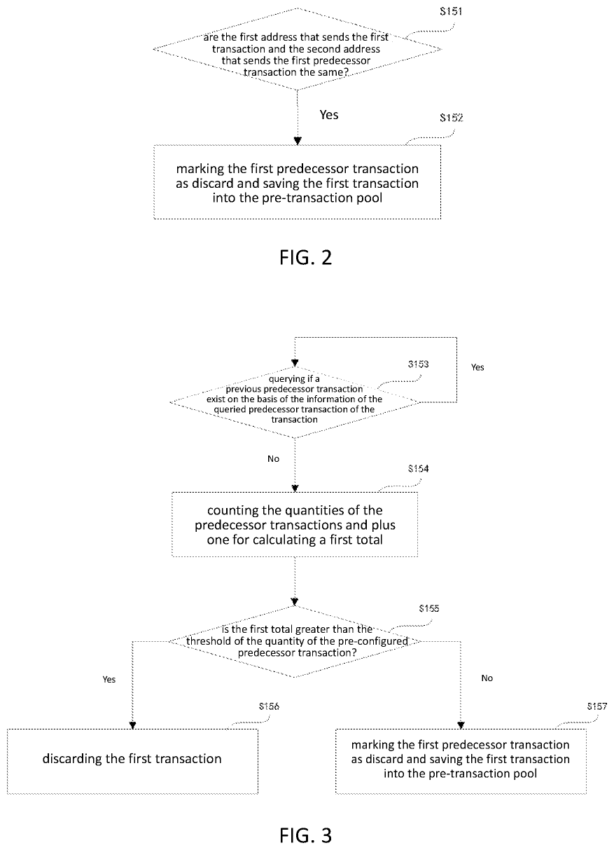

FIG. 2 is a flow diagram of a step S15 of the method illustrated in FIG. 1 according to a preferred embodiment. Referring to FIG. 2, according to a preferred embodiment, the step S15 comprises:

S151: determining if the first address that sends the first transaction and the second address that sends the first predecessor transaction are the same:

if yes, executing the step S152: marking the first predecessor transaction as discard and saving the first transaction into the pre-transaction pool.

Specifically, if the first address that sends the tx_102 and the second address that sends the tx_80 are the same.

When the node A receives the tx_102:

in the step S151, the node A judges if the first address that sends the tx_102 and the second address that sends the tx_80 are the same:

because the first address that sends the tx_102 and the second address that sends the tx_80 are the same, executing the step S152: marking the tx_80 as discard and saving the tx_102 into the pre-transaction pool.

The above embodiment prevents a different client from maliciously sending a first transaction to replace a first predecessor transaction that does not belong to him/her, so as to enhance the security of the blockchain system and further improve the user experience.

FIG. 3 is a flow diagram of a step S15 of the method illustrated in FIG. 1 according to a preferred embodiment. Referring to FIG. 3, according to a preferred embodiment, the step S15 comprises:

S153: querying if a previous predecessor transaction exist on the basis of the information of the queried predecessor transaction of the transaction and repeating this step until no more predecessor transaction was found;

S154: counting the quantities of the predecessor transactions and plus one for calculating a first total;

S155: determining if the first total is greater than the threshold of the quantity of the pre-configured predecessor transaction:

if no, executing S157: marking the first predecessor transaction as discard and saving the first transaction into the pre-transaction pool;

if yes, executing S156: discarding the first transaction.

Specifically, if the threshold of the quantity of the pre-configured predecessor transaction is 3;

in the step S153, the node A queries if a previous predecessor transaction exist on the basis of the information of the queried predecessor transaction of the transaction and repeating this step until no more predecessor transaction was found; querying if there is a previous predecessor transaction according to the predecessor of the tx_80, wherein the predecessor of tx_80 is hash(tx_60) and the previous predecessor transaction of the tx_80 is tx_60, therefore, querying if a previous predecessor transaction of the predecessor of the tx_60 exist and ending the cycle if no predecessor transaction of the tx_60 is found.

In the step S154, count the quantities of the predecessor transactions and plus one for calculating a first total, wherein if the quantity of the predecessor transaction is 1, the first total to be calculated by plus one will be 2;

In the step S155, determine if the first total is greater than the threshold of the quantity of the pre-configured predecessor transaction:

because the 2 is not greater than 3, the step S157 executed: marking the tx_80 as discard and saving the tx_102 into the pre-transaction pool.

The present embodiment will be illustrated through the above embodiment as an example that the pre-configured threshold of quantity of predecessor transaction is 3. Nevertheless, according to more embodiments, it may also, based on actual needs, configure the threshold of quantity of predecessor transaction into other numeric value, such as 5, 0, negative number (i.e. besides of the first predecessor transaction, no additional predecessor transaction is allowed), and etc., and achieve the same technical effects.

The above embodiment restricts that a transaction is not allowed to have too many predecessor transactions, so as to prevent some malicious user from jamming the pre-transaction pool through constantly sending transaction to replace a predecessor transaction, so that the security of the blockchain system can be enhanced and the user experience can be further improved.

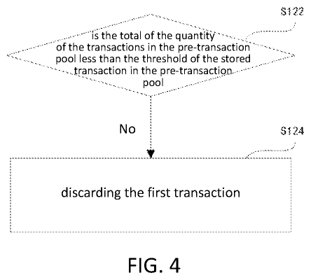

FIG. 4 is a flow diagram of a step S12 of the method illustrated in FIG. 1 according to a preferred embodiment. Referring to FIG. 4, according to a preferred embodiment, the step S12 comprises:

S122: determining if the total of the quantity of the transactions in the pre-transaction pool is less than the threshold of the stored transaction in the pre-transaction pool:

if no, executing S124: discarding the first transaction.

Specifically, if the node A receives the tx_101 and the tx_102 in order, when the node A receives the tx_101, the total quantity of transaction in the pre-transaction pool is smaller than the threshold of storing or depositing transaction of the pre-transaction pool, but when the node A receives the tx_102, the total quantity of transaction in the pre-transaction pool is not smaller than the threshold of storing or depositing transaction of the pre-transaction pool;

when the node A receives the tx_102:

in the step S122, the node A determines and judges if the total of the quantity of the transactions in the pre-transaction pool is less than the threshold of the stored transaction in the pre-transaction pool;

if no, executing S124 to discard the tx_102.

According to more embodiments, it may configure the threshold of the deposited or stored transaction of the pre-transaction pool based on actual needs, which is capable of achieving the same technical effect.

According to a preferred embodiment, configure a first threshold of deposit time for the transaction in the pre-transaction pool; monitor if the waiting time of the transaction in the pre-transaction pool is longer than the first threshold: if yes, deleting the transaction.

Specifically, for the example that the first threshold of the deposit time of the transactions in the pre-transaction pool and the waiting time of the transactions in the pre-transaction pool times from the time that the transaction enters the pre-transaction pool, it sets the waiting time of the prior tx_1 is over 10 minute.

When the node A monitors that the waiting time of the tx_1 is longer than 10 minutes, the node A will delete the tx_1.

According to the above embodiment, when the node A receives a transaction, the waiting time of the transaction in the pre-transaction pool is the time started from the moment that the transaction enters the pre-transaction pool and ended at the moment that the transaction enters the pre-transaction pool plus 10 minutes.

The present embodiment is illustrated through the example of the above embodiment that the first threshold of deposit time of the transactions stored in the pre-transaction pool is 10 minute and the waiting time of the transaction in the pre-transaction pool starts from the moment when the transaction enters the pre-transaction pool. Nonetheless, according to more embodiments, the first threshold may also be configured as, based on actual needs, for example, 5 minutes and etc., while the waiting time of the transaction in the pre-transaction pool may be configured to start from the time when the transaction is received by the node and etc., which can as well achieve the same technical effects.

The above embodiment allows deletion of the transaction with too much deposit time in the pre-transaction pool, which releases the storage space of the pre-transaction pool, therefore enhances the security of the blockchain system, and further improve the user experience.

According to the present embodiment, a transaction replacing method, provided by an embodiment of the present invention, comprises:

generating a first transaction and sending to a node of a blockchain so as for the node of the blockchain to receive the first transaction and to determine, by means of whether a first predecessor transaction information of the first transaction is null, whether the first transaction to be stored into a transaction pool is a first-type transaction for replacing a predecessor transaction or a second-type transaction not for replacing a predecessor transaction:

if the first transaction is a second-type transaction, then saving the first transaction into the pre-transaction pool;

if the first transaction is a first-type transaction, then querying whether the predecessor transaction of the first transaction is present in the pre-transaction pool on the basis of the first predecessor transaction information:

if yes, marking the first predecessor transaction as discard and saving the first transaction into the pre-transaction pool; and

sending a first confirmation message for confirming the first transaction to the node of the blockchain so as for the node of the blockchain to receive the first confirmation message, to save the first transaction into the transaction pool, and to generate a second confirmation message that confirms the first transaction and send to other node of the blockchain;

after the first transaction is packaged, querying the first predecessor transaction of the first transaction according to the first predecessor transaction information;

querying if a previous predecessor transaction exist on the basis of the information of the queried predecessor transaction of the transaction and repeating this step until no more predecessor transaction was found; and

deleting the first predecessor transaction and all the predecessor transactions that were found.

The principles of the transaction replacing of the above embodiment refer to the method, as illustrated in FIG. 1, which will not be repeated here.

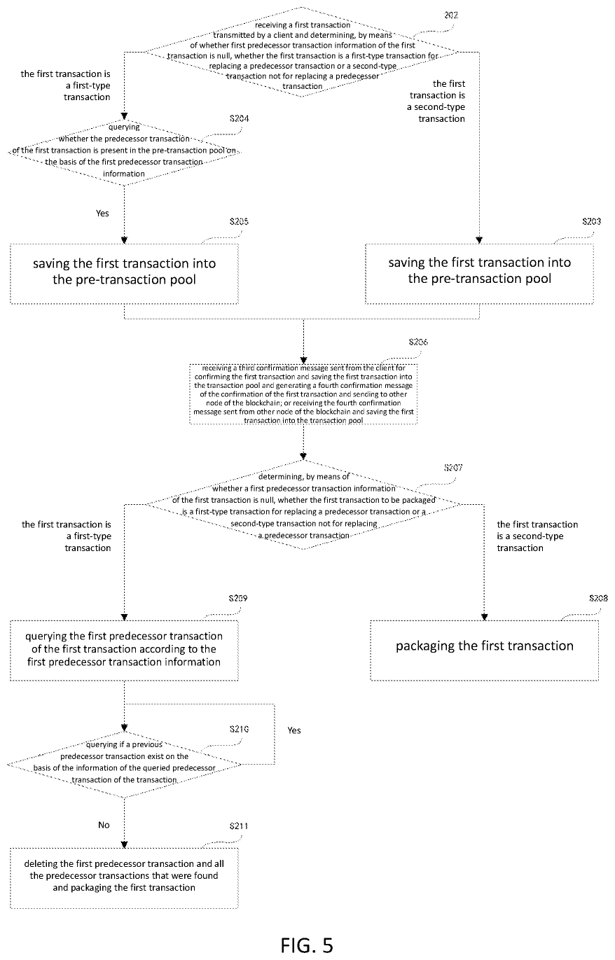

FIG. 5 is a flow diagram of a transaction replacing method according to an embodiment of the present invention. Referring to FIG. 5, according to the present embodiment, a transaction replacing method provided by the present invention comprises:

S202: receiving a first transaction transmitted by a client and determining, by means of whether a first predecessor transaction information of the first transaction is null, whether the first transaction to be stored into a transaction pool is a first-type transaction for replacing a predecessor transaction or a second-type transaction not for replacing a predecessor transaction:

if the first transaction is a second-type transaction, then executing the step S203: saving the first transaction into the pre-transaction pool;

if the first transaction is a first-type transaction, then executing the step S204:

querying whether the predecessor transaction of the first transaction is present in the pre-transaction pool on the basis of the first predecessor transaction information:

if yes, executing the step S205: saving the first transaction into the pre-transaction pool;

S206: receiving a third confirmation message sent from the client for confirming the first transaction and saving the first transaction into the transaction pool and generating a fourth confirmation message of the confirmation of the first transaction and sending to other node of the blockchain; or receiving the fourth confirmation message sent from other node of the blockchain and saving the first transaction into the transaction pool;

S207: determining, by means of whether a first predecessor transaction information of the first transaction is null, whether the first transaction to be packaged is a first-type transaction for replacing a predecessor transaction or a second-type transaction not for replacing a predecessor transaction:

if the first transaction is a second-type transaction, then executing the step S208:

packaging the first transaction;

if the first transaction is a first-type transaction, then executing the step S209: querying the first predecessor transaction of the first transaction according to the first predecessor transaction information;

S210: querying if a previous predecessor transaction exist on the basis of the information of the queried predecessor transaction of the transaction and repeating this step until no more predecessor transaction was found; and

S211: deleting the first predecessor transaction and all the predecessor transactions that were found and packaging the first transaction.

Specifically, the first transaction generated and sent by the user has a predecessor transaction message, predecessor, configured therewith. The first predecessor transaction information is the transaction hash of the predecessor transaction of the first transaction. When the first transaction does not have a predecessor transaction, the predecessor transaction message of the first transaction is null. The third confirmation message sent by the user for confirming the first transaction is the transaction hash of the first transaction that has been signed by the user. The node A generates a fourth confirmation message that confirms the first transaction, wherein the fourth confirmation message is consistent to the third confirmation message.

Assuming that there are currently 100 transactions, tx_201˜tx_300 in the pre-transaction pool and there is no transaction in the transaction pool; when the user A generates a tx_301 and a tx_302 and sends them to the node A of the blockchain, wherein the predecessor of the tx_301 is null, the predecessor of the tx_302 is hash(tx_280), the predecessor of the tx_280 is hash(tx_260), and the predecessor of the tx_260 is null, then when the user A confirms the correctness of the tx_301 and sends sig(hash(tx_301)) to the node A of the blockchain, the second confirmation message is consistent to the first confirmation message, which is also sig(hash(tx_301)); after the user A sends the tx_302, it is considered that the tx_280 is correct instead, so after the user A confirms the correctness of the tx_280 and sends sig(hash(tx_280)) to the node A of the blockchain, the second confirmation message is consistent to the first confirmation message, which is also sig(hash(tx_280)).

The user A generates the tx_301 and the tx_302 and sends them to the node A of the blockchain.

When the node A receives the tx_301:

in the step S202, the node A receives a tx_301 transmitted by the user A and determines if the tx_301 to be stored into the pre-transaction pool is a first-type transaction for replacing the predecessor transaction or a second-type transaction not for replacing the predecessor transaction by means of whether the predecessor of the tx_301 is null:

because the predecessor of the tx_301 is null, the tx_301 is a second-type transaction, therefore executing the step S203: saving the tx_301 into the pre-transaction pool.

In the step S206, the node A receives sig(hash(tx_301)) transmitted by the user A, saves the first transaction into the transaction pool, generates a fourth confirmation message that the first transaction has been confirmed, and sends the fourth confirmation message to other nodes. Because the fourth confirmation message is consistent to the third confirmation message, which is also sig(hash(tx_301)), therefore, the node A sends sig(hash(tx_301)) to other nodes of the blockchain; or the node A receives the fourth confirmation message of sig(hash(tx_301)) sent from other nodes, and saves the tx_301 into the transaction pool.

In the step S207, the node A determines, by means of whether the predecessor of the tx_301 is null, whether the tx_301 to be packaged is a first-type transaction for replacing a predecessor transaction or a second-type transaction not for replacing a predecessor transaction:

because the predecessor of the tx_301 is null, the tx_301 is a second-type transaction, therefore executing the step S208: packaging the tx_301.

When the node A receives the tx_302:

in the step S202, the node A receives a tx_302 transmitted by the user A and determines if the tx_302 to be stored into the pre-transaction pool is a first-type transaction for replacing the predecessor transaction or a second-type transaction not for replacing the predecessor transaction by means of whether the predecessor of the tx_302 is null:

because the predecessor of the tx_302 is hash(tx_280), therefore tx_302 is a first-type transaction, then executing the step S204: querying whether the predecessor transaction tx_280 of the tx_302 is present in the pre-transaction pool on the basis of the hash(tx_280):

if yes, executing the step S205: saving the tx_302 into the pre-transaction pool.

In the step S206, the node A receives sig(hash(tx_280)) transmitted by the user A, saves the tx_280 into the transaction pool, generates a fourth confirmation message that the first transaction has been confirmed, and sends the fourth confirmation message to other nodes. Because the fourth confirmation message is consistent to the third confirmation message, which is also sig(hash(tx_280)), therefore, the node A sends sig(hash(tx_280)) to other nodes of the blockchain; or the node A receives the fourth confirmation message of sig(hash(tx_280)) sent from other nodes, and saves the tx_280 into transaction pool.

In the step S207, the node A determines, by means of whether the predecessor of the tx_208 is null, whether the first transaction to be packaged is a first-type transaction for replacing a predecessor transaction or a second-type transaction not for replacing a predecessor transaction:

because the predecessor of the tx_280 is hash(tx_260), therefore tx_280 is a first-type transaction, then executing the step S209: querying if the first predecessor transaction of first the tx_280 is tx_260 according to hash(tx_260).

In the step S210, the node A queries if a previous predecessor transaction exist on the basis of the information of the queried predecessor transaction of the transaction and repeating this step until no more predecessor transaction was found; querying if there is a previous predecessor transaction according to the predecessor of the tx_260 and ending the cycle if no predecessor transaction of the tx_260 is found.

In the step S211, the node A deletes the tx_260 and package the first transaction.

The principle of preventing the transaction from being sent back is in that: when another node of the blockchain, node B for example, sends tx_260 back to the node A due to network delay or other issue; if the tx_280 has not been packaged by then, the node A determines based on that there is the tx_260 in the pre-transaction pool, so the node A will discard the tx_260 sent from the node B; if the tx_280 has been packaged by then, the node A determines that the tx_260 has been deleted from the pre-transaction pool, so the node A will check if the block height of the node B is consistent to its. Because the node A has packaged the tx_280 and the node B is still in the stage of sending back tx_260, the block height of the node A is certainly higher than the block height of the node B. Therefore, the node A will discard the tx_260 sent from the node B.

The above embodiment utilizes a method including: receiving a first transaction transmitted by a client and determining, by means of whether a first predecessor transaction information of the first transaction is null, whether the first transaction to be stored into a transaction pool is a first-type transaction for replacing a predecessor transaction or a second-type transaction not for replacing a predecessor transaction: if the first transaction is a second-type transaction, saving the first transaction into the pre-transaction pool; if the first transaction is a first-type transaction, then querying whether the predecessor transaction of the first transaction is present in the pre-transaction pool on the basis of the first predecessor transaction information: if yes, saving the first transaction into the pre-transaction pool; receiving a third confirmation message sent from the client for confirming the first transaction and saving the first transaction into the transaction pool and generating a fourth confirmation message of the confirmation of the first transaction and sending to other node of the blockchain; or receiving the fourth confirmation message sent from other node of the blockchain and saving the first transaction into the transaction pool; determining, by means of whether a first predecessor transaction information of the first transaction is null, whether the first transaction to be packaged is a first-type transaction for replacing a predecessor transaction or a second-type transaction not for replacing a predecessor transaction: if the first transaction is a second-type transaction, then packaging the first transaction; if the first transaction is a first-type transaction, then querying the first predecessor transaction of the first transaction according to the first predecessor transaction information, querying if a previous predecessor transaction exist on the basis of the information of the queried predecessor transaction of the transaction and repeating this step until no more predecessor transaction was found; and deleting the first predecessor transaction and all the predecessor transactions that were found and packaging the first transaction. Therefore, it allows modification of the transaction content before the transaction enters the transaction pool and prevents the transaction from being sent back. Besides, the user is capable of selectively assigning transaction(s) that require confirmation, which further enhances the user experience.

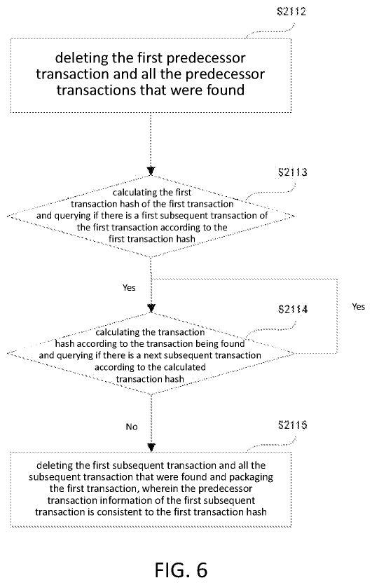

FIG. 6 is a flow diagram of a step S211 of the method of FIG. 5 according to a preferred embodiment. Referring to FIG. 6, according to a preferred embodiment, the step S211 comprises:

S2112: deleting the first predecessor transaction and all the predecessor transactions that were found;

S2113: calculating the first transaction hash of the first transaction and querying if there is a first subsequent transaction of the first transaction according to the first transaction hash:

if yes, executing the step S2114: calculating the transaction hash according to the transaction being found and querying if there is a next subsequent transaction according to the calculated transaction hash and repeating this step until no more subsequent transaction was found;

S2115: deleting the first subsequent transaction and all the subsequent transaction that were found and packaging the first transaction;

wherein the predecessor transaction information of the first subsequent transaction is consistent to the first transaction hash.

Specifically, in the step S2112, the node A deletes the tx_260.

In the step S2113, the node A calculates the transaction hash of the tx_280 to obtain hash(tx_280) and then queries, according to hash(tx_280), if the subsequent transaction of tx_280 exists.

Because the predecessor of the tx_302 is hash(tx_280), it is found that the subsequent transaction of the tx_280 is tx_302, therefore executing the step S2114 to query if there is a next subsequent transaction based on the calculated transaction hash and repeating this step until no more subsequent transaction was found; the node A calculates the transaction hash of the tx_302 to obtain hash(tx_302) and, according to hash(tx_302), is unable to find a subsequent transaction of the tx_302, thereby ending the cycle.

In the step S2115, the node A deletes the tx_302 and packages the tx_280.

According to a preferred embodiment, the step of saving the first transaction into the pre-transaction pool package comprises:

determining if the first address that sends the first transaction and the second address that sends the first predecessor transaction are the same:

if yes, saving the first transaction into the pre-transaction pool.

The principles of the transaction replacing of the above embodiment refer to the method, as illustrated in FIG. 2, which will not be repeated here.

According to a preferred embodiment, if the first transaction is a first-type transaction, the step of saving the first transaction into the pre-transaction pool package comprises:

querying if a previous predecessor transaction exist on the basis of the information of the queried predecessor transaction of the transaction and repeating this step until no more predecessor transaction was found;

counting the quantities of the predecessor transactions and plus one for calculating a first total;

determining if the first total is greater than the threshold of the quantity of the pre-configured predecessor transaction:

if no, saving the first transaction into the pre-transaction pool;

if yes, discarding the first transaction.

The principles of the transaction replacing of the above embodiment refer to the method, as illustrated in FIG. 3, which will not be repeated here.

According to a preferred embodiment, the step of receiving a first transaction transmitted by a client and determining, by means of whether a first predecessor transaction information of the first transaction is null, whether the first transaction to be stored into a transaction pool is a first-type transaction for replacing a predecessor transaction or a second-type transaction not for replacing a predecessor transaction also comprises:

determining if the total of the quantity of the transactions in the pre-transaction pool is less than the threshold of the stored transaction in the pre-transaction pool;

if no, discarding the first transaction.

The principles of the transaction replacing of the above embodiment refer to the method, as illustrated in FIG. 4, which will not be repeated here.

According to a preferred embodiment, configure a first threshold of deposit time for the transaction in the pre-transaction pool; monitor if the waiting time of the transaction in the pre-transaction pool is longer than the first threshold: if yes, deleting the transaction.

Specifically, for the example that the first threshold of the deposit time of the transactions in the pre-transaction pool and the waiting time of the transactions in the pre-transaction pool times from the time that the transaction enters the pre-transaction pool, it sets the waiting time of the prior tx_201 is over 10 minute.

When the node A monitors that the waiting time of the tx_201 is longer than 10 minutes, the node A will delete the tx_201.

According to the above embodiment, when the node A receives a transaction, the waiting time of the transaction in the pre-transaction pool is the time started from the moment that the transaction enters the pre-transaction pool and ended at the moment that the transaction enters the pre-transaction pool plus 10 minutes.

According to the present embodiment, a transaction replacing method, provided by an embodiment of the present invention, comprises:

generating a first transaction and sending to a node of a blockchain so as for the node of the blockchain to receive the first transaction and to determine, by means of whether a first predecessor transaction information of the first transaction is null, whether the first transaction to be stored into a transaction pool is a first-type transaction for replacing a predecessor transaction or a second-type transaction not for replacing a predecessor transaction:

if the first transaction is a second-type transaction, then saving the first transaction into the pre-transaction pool;

if the first transaction is a first-type transaction, then querying whether the predecessor transaction of the first transaction is present in the pre-transaction pool on the basis of the first predecessor transaction information:

if yes, saving the first transaction into the pre-transaction pool;

sending a third confirmation message for confirming the first transaction to the node of the blockchain so as for the node of the blockchain to receive the third confirmation message, to save the first transaction into the transaction pool, and to generate a fourth confirmation message that confirms the first transaction and send to other node of the blockchain, and determining, by means of whether a first predecessor transaction information of the first transaction is null, whether the first transaction to be packaged is a first-type transaction for replacing a predecessor transaction or a second-type transaction not for replacing a predecessor transaction:

if the first transaction is a second-type transaction, then packaging the first transaction;

if the first transaction is a first-type transaction, then querying the predecessor transaction of the first transaction according to the first predecessor transaction information;

querying if a previous predecessor transaction exist on the basis of the information of the queried predecessor transaction of the transaction and repeating this step until no more predecessor transaction was found; and

deleting the first predecessor transaction and all the predecessor transactions that were found and packaging the first transaction.

The principles of the transaction replacing of the above embodiment refer to the method, as illustrated in FIG. 5, which will not be repeated here.

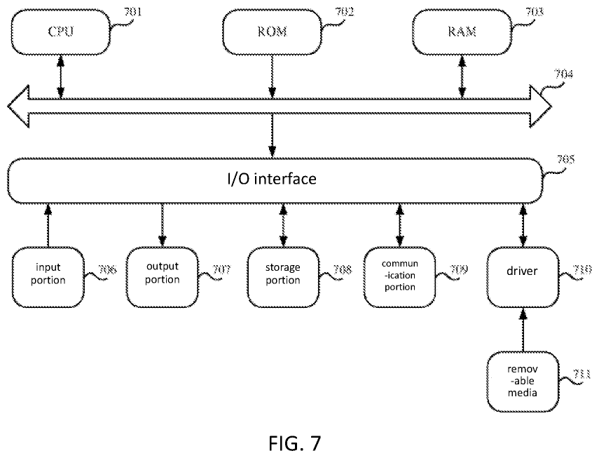

FIG. 7 is a composition diagram of a device according to an embodiment of the present invention.

Referring to FIG. 7, in another aspect, the present application also provides a device 700, which includes one or more central processing units (CPUs) 701 that can perform various suitable actions and processes in accordance with a program stored in a read-only memory (ROM) 702 or a program loaded into a random access memory (RAM) 703 from a storage portion 708. Various programs and data required for the operation of the device 700 are also stored in the RAM 703. The CPU 701, the ROM 702, and the RAM 703 are connected to each other via a bus 704. An input/output (I/O) interface 705 is also connected to the bus 704.

The following components are connected to the I/O interface 705: an input portion 706 including a keyboard, a mouse, and etc.; an output portion 707 including a cathode ray tube (CRT), a liquid crystal display (LCD), and etc., and a speaker and etc.; a storage portion 708 including a hard disk or the like; and a communication portion 709 including a network interface card, such as a LAN card, a modem, and etc. The communication portion 709 performs communication process via a network, such as the Internet. A driver 710 is also connected to the I/O interface 705 based on the needs. A removable media 711, such as magnetic disks, optical disks, magneto-optical disks, semiconductor memories, and etc., is mounted on the driver 710 based on the needs so that the computer programs read therefrom can be installed into the storage portion 708 as needed.

In particular, according to the embodiments of the present invention, the transaction replacing method described in any of the above embodiments may be implemented as the computer program. For example, an embodiment of the present invention may provide a computer program product, which includes a computer program tangibly loaded on a machine-readable medium containing program code for performing a transaction replacing method. According to such embodiment, the computer program may be downloaded and installed from the network through the communication portion 709 and/or installed from the removable medium 711.

As yet another aspect, the present application also provides a computer-readable storage medium, which may be a computer-readable storage medium included in a device of the above-described embodiments, or a computer-readable storage medium that may be provided separately, without being assembled in the device. The computer-readable storage medium stores one or more programs that are utilized by one or more processors to perform a transaction replacing method disclosed in the present application.

The flow chart and block diagrams in the figures illustrate the constructions, functionality, and operation of possible implementations of the systems, methods, and computer program products according to various embodiments of the present invention. In this regard, each block in the flow chart or block diagrams may represent a module, segment, or portion of code, which includes one or more executable instructions for implementing the specified logical function (s). It should also be noted that, in some alternative implementations, the functions illustrated in the block may occur out of the order illustrated in the figures. For example, two blocks represented in succession may, in fact, be executed substantially concurrently, or the blocks may sometimes be executed in the reverse order, depending upon the functionality involved. It will also be noted that each block of the block diagrams and/or flow chart illustration, and combinations of the blocks in the block diagrams and/or flow chart illustration, may be implemented by special purpose hardware-based systems that perform the specified functions or acts, or combinations of special purpose hardware and computer instructions.

The units or modules described in the embodiments of the present application may be implemented in a software manner, or may be implemented in a hardware manner. The described units or modules may also be provided in a processor, for example, each of which may be a software program disposed in a computer or a mobile smart device or a separately configured hardware device. The names of these units or modules, in some cases, do not constitute a definition of the unit or module itself

The above description is merely preferred embodiment(s) of the present application and is intended to be illustrative of the principles of the application. It should be understood by those skilled in the art that the scope of the present invention referred to herein is not limited to the particular combination of the above-described technical features, but also to other technical solutions formed by any combination of the above-described technical features or the equivalent features thereof without departing from the concepts of the present application. For example, technical solutions that are formed through alternating or interchanging the features described above and the technical features disclosed in this application (but are not limited to) with similar feature(s).

1: A transaction replacing method, comprising steps of:
receiving a first transaction transmitted by a client and determining, by means of whether a first predecessor transaction information of the first transaction is null, whether the first transaction to be stored into a transaction pool is a first-type transaction for replacing a predecessor transaction or a second-type transaction not for replacing a predecessor transaction:
if the first transaction is a second-type transaction, then saving the first transaction into the pre-transaction pool;
if the first transaction is a first-type transaction, then querying whether the predecessor transaction of the first transaction is present in the pre-transaction pool on the basis of the first predecessor transaction information:
if yes, marking the first predecessor transaction as discard and saving the first transaction into the pre-transaction pool; and
receiving a first confirmation message sent from the client for confirming the first transaction and saving the first transaction into the transaction pool and generating a second confirmation message of the confirmation of the first transaction and sending to other node of the blockchain; or receiving the second confirmation message sent from other node of the blockchain and saving the first transaction into the transaction pool;
after the first transaction is packaged, querying the first predecessor transaction of the first transaction according to the first predecessor transaction information;
querying if a previous predecessor transaction exist on the basis of the information of the queried predecessor transaction of the transaction and repeating this step until no more predecessor transaction was found; and
deleting the first predecessor transaction and all the predecessor transactions that were found.

2: The method, as recited in claim 1, marking the first predecessor transaction as discard and saving the first transaction into the pre-transaction pool, comprising:
determining if the first address that sends the first transaction and the second address that sends the first predecessor transaction are the same:
if yes, marking the first predecessor transaction as discard and saving the first transaction into the pre-transaction pool.

3: The method, as recited in claim 1, wherein when marking the first predecessor transaction as discard and saving the first transaction into the pre-transaction pool, the method further comprises:
querying if a previous predecessor transaction exist on the basis of the information of the queried predecessor transaction of the transaction and repeating this step until no more predecessor transaction was found;
counting the quantities of the predecessor transactions and calculating a first total;
determining if the first total is greater than the threshold of the quantity of the pre-configured predecessor transaction:
if no, marking the first predecessor transaction as discard and saving the first transaction into the pre-transaction pool;
if yes, discarding the first transaction.

4: The method, as recited in claim 1, wherein when receiving a first transaction transmitted by a client and determining, by means of whether a first predecessor transaction information of the first transaction is null, whether the first transaction to be stored into a transaction pool is a first-type transaction for replacing a predecessor transaction or a second-type transaction not for replacing a predecessor transaction, the method further comprises:
determining if the total of the quantity of the transactions in the pre-transaction pool is less than the threshold of the stored transaction in the pre-transaction pool.
if no, discarding the first transaction.

5: The method, as recited in claim 1, further comprising steps of:
configuring a first threshold of the deposit time of the transaction in the pre-transaction pool; and
monitoring if the waiting time of the transaction of the pre-transaction pool is longer than the first threshold: if yes, deleting the transaction.

6: A transaction replacing method, comprising steps of:
generating a first transaction and sending to a node of a blockchain so as for the node of the blockchain to receive the first transaction and to determine, by means of whether a first predecessor transaction information of the first transaction is null, whether the first transaction to be stored into a transaction pool is a first-type transaction for replacing a predecessor transaction or a second-type transaction not for replacing a predecessor transaction:
if the first transaction is a second-type transaction, then saving the first transaction into the pre-transaction pool;
if the first transaction is a first-type transaction, then querying whether the predecessor transaction of the first transaction is present in the pre-transaction pool on the basis of the first predecessor transaction information:
if yes, marking the first predecessor transaction as discard and saving the first transaction into the pre-transaction pool; and
sending a first confirmation message for confirming the first transaction to the node of the blockchain so as for the node of the blockchain to receive the first confirmation message, to save the first transaction into the transaction pool, and to generate a second confirmation message that confirms the first transaction and send to other node of the blockchain;
after the first transaction is packaged, querying the first predecessor transaction of the first transaction according to the first predecessor transaction information;
querying if a previous predecessor transaction exist on the basis of the information of the queried predecessor transaction of the transaction and repeating this step until no more predecessor transaction was found; and
deleting the first predecessor transaction and all the predecessor transactions that were found.

7: A transaction replacing method, comprising steps of:
receiving a first transaction transmitted by a client and determining, by means of whether a first predecessor transaction information of the first transaction is null, whether the first transaction to be stored into a transaction pool is a first-type transaction for replacing a predecessor transaction or a second-type transaction not for replacing a predecessor transaction:
if the first transaction is a second-type transaction, then saving the first transaction into the pre-transaction pool;
if the first transaction is a first-type transaction, then querying whether the predecessor transaction of the first transaction is present in the pre-transaction pool on the basis of the first predecessor transaction information:
if yes, saving the first transaction into the pre-transaction pool;
receiving a third confirmation message sent from the client for confirming the first transaction and saving the first transaction into the transaction pool and generating a fourth confirmation message of the confirmation of the first transaction and sending to other node of the blockchain; or receiving the fourth confirmation message sent from other node of the blockchain and saving the first transaction into the transaction pool;
determining, by means of whether a first predecessor transaction information of the first transaction is null, whether the first transaction to be packaged is a first-type transaction for replacing a predecessor transaction or a second-type transaction not for replacing a predecessor transaction:
if the first transaction is a second-type transaction, then packaging the first transaction;
if the first transaction is a first-type transaction, then querying the first predecessor transaction of the first transaction according to the first predecessor transaction information,
querying if a previous predecessor transaction exist on the basis of the information of the queried predecessor transaction of the transaction and repeating this step until no more predecessor transaction was found; and
deleting the first predecessor transaction and all the predecessor transactions that were found and packaging the first transaction.

8: The method, as recited in claim 7, wherein the predecessor transaction information comprises the transaction hash of the predecessor transaction, the deleted first predecessor transaction, and all the predecessor transactions that were found, packaging the first transaction and comprising:
deleting the first predecessor transaction and all the predecessor transactions that were found;
calculating the first transaction hash of the first transaction and querying if there is a first subsequent transaction of the first transaction according to the first transaction hash:
if yes, calculating the transaction hash according to the transaction being found and querying if there is a next subsequent transaction according to the calculated transaction hash and repeating this step until no more subsequent transaction was found; and
deleting the first subsequent transaction and all the subsequent transactions that were found and packaging the first transaction;
wherein the predecessor transaction information of the first subsequent transaction is consistent to the first transaction hash.

9: The method, as recited in claim 7, wherein when saving the first transaction into the pre-transaction pool if the first transaction is the first-type transaction, the method further comprises:
determining if the first address that sends the first transaction and the second address that sends the first predecessor transaction are the same:
if yes, saving the first transaction into the pre-transaction pool.

10: The method, as recited in claim 7, wherein when saving the first transaction into the pre-transaction pool if the first transaction is the first-type transaction, the method further comprises:
querying if a previous predecessor transaction exist on the basis of the information of the queried predecessor transaction of the transaction and repeating this step until no more predecessor transaction was found;
counting the quantities of the predecessor transactions and calculating a first total; and
determining if the first total is greater than the threshold of the quantity of the pre-configured predecessor transaction:
if no, saving the first transaction into the pre-transaction pool;
if yes, discarding the first transaction.

11: The method, as recited in claim 7, wherein when receiving a first transaction transmitted by a client and determining, by means of whether a first predecessor transaction information of the first transaction is null, whether the first transaction to be stored into a transaction pool is a first-type transaction for replacing a predecessor transaction or a second-type transaction not for replacing a predecessor transaction, the method further comprises:
determining if the total of the quantity of the transactions in the pre-transaction pool is less than the threshold of the stored transaction in the pre-transaction pool;
if no, discarding the first transaction.

12: The method, as recited in claim 7, further comprising steps of:
configuring a first threshold of the deposit time of the transaction in the pre-transaction pool; and
configuring if the waiting time of the transaction of the pre-transaction pool is longer than the first threshold: if yes, deleting the transaction.

13: A transaction replacing method, comprising steps of:
generating a first transaction and sending to a node of a blockchain so as for the node of the blockchain to receive the first transaction and to determine, by means of whether a first predecessor transaction information of the first transaction is null, whether the first transaction to be stored into a transaction pool is a first-type transaction for replacing a predecessor transaction or a second-type transaction not for replacing a predecessor transaction:
if the first transaction is a second-type transaction, then saving the first transaction into the pre-transaction pool;
if the first transaction is a first-type transaction, then querying whether the predecessor transaction of the first transaction is present in the pre-transaction pool on the basis of the first predecessor transaction information:
if yes, saving the first transaction into the pre-transaction pool;
sending a third confirmation message for confirming the first transaction to the node of the blockchain so as for the node of the blockchain to receive the third confirmation message, to save the first transaction into the transaction pool, and to generate a fourth confirmation message that confirms the first transaction and send to other node of the blockchain, and determining, by means of whether a first predecessor transaction information of the first transaction is null, whether the first transaction to be packaged is a first-type transaction for replacing a predecessor transaction or a second-type transaction not for replacing a predecessor transaction:
if the first transaction is a second-type transaction, then packaging the first transaction;
if the first transaction is a first-type transaction, then querying the predecessor transaction of the first transaction according to the first predecessor transaction information,
querying if a previous predecessor transaction exist on the basis of the information of the queried predecessor transaction of the transaction and repeating this step until no more predecessor transaction was found; and
deleting the first predecessor transaction and all the predecessor transactions that were found and packaging the first transaction.

14-15. (canceled)
